(19) United States
(12) Patent Application Publication
(10) Pub. No.: US 2009/0077550 A1
(43) Pub. Date: Mar. 19, 2009

(54) VIRTUAL MACHINE SCHEDULAR WITH MEMORY ACCESS CONTROL

(76) Inventor: Scott Rhine, Isanti, MN (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/855,121

(22) Filed: Sep. 13, 2007

(51) Int. Cl. G06F 9/455

(52) U.S. Cl. 718/1

(57) ABSTRACT

A computer system comprises a virtual machine scheduler that dynamically and with computed automation controls non-uniform memory access of a plurality of cells in interleaved and cell local configurations. The virtual machine scheduler maps logical central processing units (CPUs) to physical CPUs according to preference and solves conflicts in preference based on a predetermined entitlement weight and iterative switching of individual threads.

### BACKGROUND

A multiprocessor computing system can include multiple processors, memory, and input/output (I/O) grouped into cells. Physical memory is the physical arrangement and connection of memory to other parts of the system. Memory can include interleaved memory and cell local memory. For example, a portion of memory can be taken from cells—typically all cells—in the system and is combined in a round-robin fashion of same-sized chunks, for example as is used in disk striping. For interleaved memory, random accesses from every processor average the same amount of time so that latency appears uniform no matter which processor is accessing the memory. Although local memory is accessible to any processor, processors on the same cell have lowest latency for memory accesses. Accesses from other cells take longer and thus have greater latency in comparison to accesses from the same cell in a process known as Non-Uniform Memory Access (NUMA).

Accordingly, in cell-based systems, the distance from a central processing unit (CPU) to memory in a different cell is greater than the distance to memory in the local cell. Thus, an operating system can manage memory access to enable a programmer to have some control in laying out an application to obtain the most optimal performance.

One conceptual entity is fast or local cell memory. Some systems enable usage of a command that is used at system startup to specify the percentage of memory which will not be accessed as cell local memory by each cell. What is not allocated as cell local memory is maintained as interleaved memory. The interleaved memory from each cell in a partition can be shared across the entire system. Thus, allocation of memory into interleaved and local cell memory is bound at startup.

### SUMMARY

An embodiment of a computer system comprises a virtual machine scheduler that dynamically and with computed automation controls non-uniform memory access of a plurality of cells in interleaved and cell local configurations. The virtual machine scheduler maps logical central processing units (CPUs) to physical CPUs according to preference and solves conflicts in preference based on a predetermined entitlement weight and iterative switching of individual threads.

### BRIEF DESCRIPTION OF THE DRAWINGS

Embodiments of the invention relating to both structure and method of operation may best be understood by referring to the following description and accompanying drawings:

FIG. 1 is a schematic block diagram depicting an embodiment of a computer system that includes a cell-aware Virtual Machine (VM) scheduler;

FIG. 2 is a schematic flow chart illustrating an embodiment of a computer-executed method for virtual machine scheduling;

FIG. 3 is are flow chart illustrating an embodiments of a computer automated method for scheduling virtual machines which uses analysis based on graph theory; and

FIGS. 4A through 4E are flow charts showing one or more embodiments or aspects of a computer-executed method for virtual machine scheduling.

### DETAILED DESCRIPTION

Binding of memory at initialization can result in inefficient allocation of cell local and interleaved memory during processing of various jobs and workloads.

A cell-aware Virtual Machine (VM) scheduler enables improved system performance.

Non-uniform memory access architectures on large cellular servers enable usage of two types of memory including interleaved and cell local memory. Some input/output (I/O) based applications, for example databases, benefit significantly by being bound to a specific cell and using only memory from the bound cell. Accordingly, scheduling can be controlled to ensure Virtual Machines (VMs) attain a maximum throughput from a host machine, and also that the VMs which can benefit from locality can receive preferential treatment in appropriate conditions.

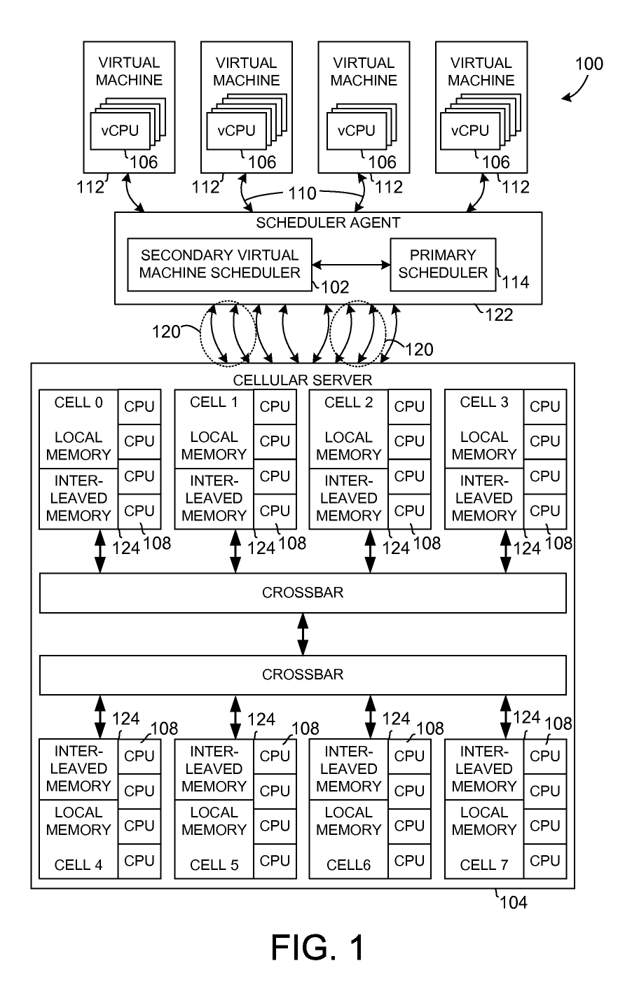

Referring to FIG. 1, a schematic block diagram depicts an embodiment of a computer system 100 that includes a cell-aware Virtual Machine (VM) scheduler 102. The illustrative computer system 100 comprises a virtual machine scheduler 102 that dynamically and with computed automation controls non-uniform memory access of a cellular server 104 in interleaved and cell local configurations. The virtual machine scheduler 102 is operative to map logical central processing units (CPUs) 106 to physical CPUs 108 according to preference and solves conflicts in preference based on a predetermined entitlement weight and iterative switching of individual threads 110.

A logical CPU 106 can be defined as a container/bin that holds zero or more threads which share the processor (CPU 106). The logical CPUs, as abstract identical containers, are mapped to physical CPUs that have architectural and/or topological constraints and differences. An example constraint of a physical CPU is clock speed. In practice, if one physical CPU runs slower than other due to heat, the illustrative system can operate to allocate a lower load or only idle guest threads to the overheated CPU. A virtual machine 112 can contain multiple virtual CPUs 106 or threads.

The virtual machine scheduler 102 can respond to a change in workload by adjusting binding of the cellular server 104 in the interleaved and cell local configurations for multiple virtual central processing units (vCPUs) 110.

In an illustrative operation, the virtual machine scheduler 102 can solve conflicts in preference such as a condition in which logical CPU demand exceeds the supply of physical CPUs 108 or a condition in which a logical CPU 106 has a preference for more than a single physical CPU 108.

For example, the memory aware virtual machine scheduler 102 can select scheduling of activation and deactivation of particular virtual machines 112. The virtual machine scheduler 102 can distribute virtual machine load over cells in a substantially equal allocation. In a particular application, the virtual machine scheduler 102 can operate as a secondary scheduler supporting a primary scheduler 114 which schedules substantially equal virtual machine work for each of multiple physical CPUs 108. Typically, a cell 124 in the cellular server 104 can include multiple physical CPUs 108, for example at least four CPUs 108 in an illustrative implementation.

The virtual machine scheduler 102 can assign preference to virtual machines 112 accordingly to any suitable criteria for various applications. For example, preference can be favored for virtual machines 112 with a highest assigned business priority.

The virtual machine scheduler 102 maps logical CPUs 106 onto physical CPUs 108 as schedulable hardware entities which can be defined by locality domain (LDOM) preferences while allowing for null cases and conflicts to be resolved. In an illustrative implementation, the virtual machine scheduler 102 can map logical processing units 106 as a set of threads 110 from different virtual machines 112 for eventual binding to a single physical CPU 108. For example, the virtual machine scheduler 102 can map multiple logical processing units 106 with approximately equal entitlement weight.

A locality domain (LDOM) can be defined as a related collection of processors, memory, and peripheral resources that compose a fundamental building block of the system. Processors and peripheral devices in a particular locality domain have equal latency to the memory contained within that locality domain. A cell includes both interleave and local memory in combination with other hardware. A locality is a subset of memory in the cell.

In some embodiments, the virtual machine scheduler 102 can distribute groups of associated threads 110 into classes 120.

In a particular implementation, the virtual machine scheduler 102 can further comprise a scheduler agent 122 that detects an imbalanced configuration and responds by rotating threads 118 within a locality domain (LDOM) 124. For example, the virtual machine scheduler 102 can distribute the logical CPUs 106 into classes 120 and perform locality domain (LDOM) optimization by selecting a best estimate mapping from schedulable hardware entities to LDOMs 124, and swapping places between logical CPUs 106 to remove conflicts between jobs executing on schedulable hardware entities.

The illustrative computer system 100 and virtual machine scheduler 102 enable an improved application speed. For example, for a system configuration including local memory with access speed of 500 nanoseconds (ns) and an off-cell memory with speed of 800 ns per access, the average access time for a two-cell system using interleaved memory which round-robins between each cell is therefore (500+800)/2=650 ns. The depicted computer system 100 and virtual machine scheduler 102 can be operated to reduce the access time for an application by using cell local memory and binding to the local cell, thus saving 150/650=20 percent overhead. As the number of cells or nodes increases, the savings correspondingly improves.

The depicted computer system 100 and virtual machine scheduler 102 also enable selectivity of applications. Some virtual machines may have characteristics such that scheduling does not attain improved performance in some aspect of operation. Accordingly, the virtual machine scheduler 102 can be implemented with selective or optional operation. The functionality can be activated or deactivated for individual virtual machines.

The illustrative computer system 100 and virtual machine scheduler 102 can also be implemented in combination with load balancing operations. For applications that benefit from virtual machine scheduling, load can be distributed over cells equally so that no cell has too much contention.

Virtual machine scheduling can be implemented to avoid interference with a typical primary goal of maintaining or improving throughput. Thus, the virtual machine scheduler 102 can be configuration as a secondary scheduler that is subservient to a main throughput scheduler which schedules the same amount of VM work for each physical CPU. For example, a cell solver that places all jobs on just one of the two available cells can degrade all users by 50 percent. The virtual machine scheduler 102 can be formed to use all CPUs to fullest capabilities and maintain minimum resource allocations fairly before addressing a mere extra 20 percent savings.

Virtual machine scheduling can also be implemented to select job priority. The depicted solver enables preference for VMs with highest business priority first. Applications that are penalized can be ensured to be the least important.

The illustrative computer system 100 and virtual machine scheduler 102 improve over a system with a capability for cellular awareness alone which involves manual binding and does not automatically balance loads or allow per-workload selection of memory preference since some workloads are degraded by operation of cell memory. Furthermore, the depicted computer system 100 and virtual machine scheduler 102 also enable maximization of host throughput by temporarily putting some jobs on a non-home cell when appropriate and facilitate operations with VM minimum and maximum CPU resource constraints.

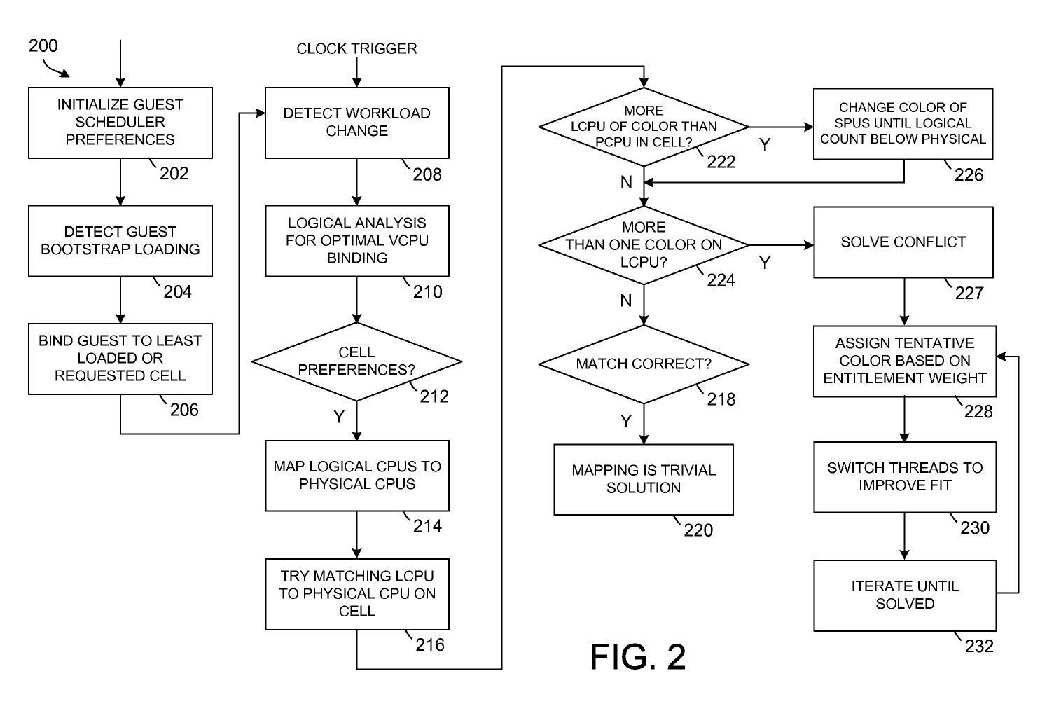

Referring to FIG. 2, a schematic flow chart illustrates an embodiment of a computer-executed method 200 for virtual machine scheduling. The scheduling operation is initialized by setting 202 for each guest a tunable called sched_preference that is set to a cell number or BEST where BEST designates maximum preference. Upon guest bootstrap loading 204, the guest is bound 206 to a least loaded or least requested cell.

Every time workloads change 208, for example due to changes in entitlement, idle/busy states, and start/stop status, logical solution analysis is performed 210 to solve an optimal binding for each virtual machine thread. Workload change 208 is traditionally activated by a clock trigger, which can be operative in the illustrative method 200.

If cell preferences exist 212, analysis is performed to map 214 logical CPUs to physical CPUs. Any matching may be appropriate, for example a trivial first-come-first-serve technique. Each logical CPU with a preference is attempted to match 216 to a physical CPU on the desired cell. If matching is correct 218, mapping is complete 220 according to a trivial solution. In accordance with “color” representation in graph theory, if more logical CPUs are present for a certain “color” than physical CPUs are available 222 in a desired cell, “color” of the least desirable SPUs is changed 226 until the logical count is below the physical count. During adjustment 226 of least-desirable CPU color, SPU/LDOM pairs can be tagged to avoid relapse and to avoid infinite loops. If sufficient physical CPUs are available for the logical CPUs of the “color” under analysis 222 or “color” is modified 226 to attain the suitable logical count, then if more than one “color” is scheduled on a particular logical CPU 224, analysis is performed 227 to solve the conflict. The physical CPU count is checked against the count of a target cell for each cell-local LDOM. First, a tentative color is assigned 228 to the first undecided LCPU based on total entitlement weight. The LCPUs that are most easily resolved can be assigned 228 first since solving for easiest LCPUs with swapping can often simplify combination conditions for other LCPUs. Second, switching 230 of individual threads is attempted to improve fit. The first and second steps are heuristic and iterative 232 with looping until assignment is solved. The iteration of assignment 228 and switching 230 steps generally works well because most entitlements are either the same or fall into a limited number of sizes that are multiples of one another. The number of iteration steps is limited to the number of undecided logical CPUs.

In an example implementation, matching is correct 218 if sufficient physical CPUs are available to handle logical CPUs of a certain “color” and a single “color” is scheduled on a particular logical CPU.

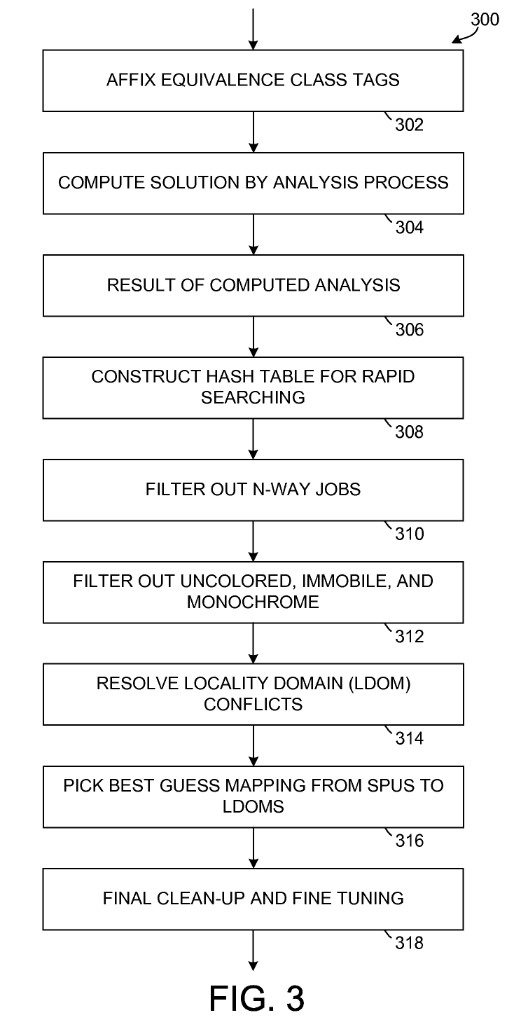

Referring to FIG. 3, a flow chart illustrates an embodiment of a computer-executed method for virtual machine scheduling using analysis based on graph theory. The illustrative method maps a logical solution, for example including locality domain (LDOM) preferences, onto physical CPUs. Graph theory can be used to implement a concept of single processing unit (SPU) “color” that can relate, for example, to LDOM identification (ID) number. A single processing unit (SPU) refers to a schedulable hardware entity. In an illustrative embodiment, SPU color relates to LDOM ID number and also addresses SPU conditions including a null case defined as “COLOR_NONE” and a conflict to be resolved defined as “COLOR_MIXED”. In any case, SPU color can never go negative, enabling usage as an array index.

Another concept addressed by a module that performs virtual machine scheduling is equivalence class. In partially order sets, a collection of items, for example virtual CPUs (vCPUs), can be interchangeable whereby the items have the same weight and any can be exchanged with any other item without loss of correctness or notice by the user because the expected number of cycles achieved and entitlement is identical. Determination of class is trivial when performed at the start of an abstraction when all items are sorted in descending order according to selected criteria. An integer class identifier (ID) can be set as an identifier for any suitable resource management technique including processor set methods. The integer class ID can be a scheduler group number for a first guest in a list with a unique weight combination signature. A guest that is the only member in a class can devolve equivalence class 0. The group number can be used subsequently for long term scheduler rotation, LDOM solution optimization, and the like. In a scheduler rotation operation, a scheduler agent can respond to an imbalanced configuration by rotating equivalent vCPUs within an LDOM in cases that a domain preference is specified, or across the entire host if none is specified.

Referring to FIG. 3, a flow chart depicts a technique for locality domain (LDOM) optimization 300. Before the solution is computed by an analysis process 304, equivalence class tags can be affixed 302. The solution can be computed 304 in a color blind fashion for maximum machine utilization and smooth workflow. The result of the analysis solution is received 306 and, to facilitate rapid searching, a hash table linked list can be constructed 308 with an entry for every possible equivalence class ID. Rotation use of the equivalence class tag can be unlinked since optimization swapping is never valuable between members of the same LDOM. Therefore, any “monochrome” lists can be discarded at the start of optimization to save search time. The hash table link list is constructed to facilitate conflict resolution. Filtering can be performed to reduce combinatorics (combinational mathematics). For example, N-way jobs can be removed by filtering 310, and uncolored, immobile, and monochrome jobs can similarly be eliminated by filtering 312. The filtered analysis solution can be used to resolve 314 locality domain (LDOM) conflicts, for example by picking 316 a best guess mapping from SPUs to LDOMs and thus generating an output in the form of a color map, and performing 322 final clean-up and fine tuning, for example by swapping positions between virtual CPUs (vCPUs) that reduce the number of conflicts wherein a job of one color is running on a SPU of a different color. From the perspective of the caller, the swap has no affect because the choice between members of the class is arbitrary. Once the final logical CPU color is assigned, a final pass can be made to move off threads of the wrong color. In an example embodiment, a cleanup_orphans function can be defined as a utility that is typically called on a last pass at cleaning up any orphans, which are typically single event occurrences, that may have been overlooked in the bulk operations.

A further concept that can be implemented is immovability. If a group has no color or has no members in an equivalence list (equiv_list), the group is considered immovable. When making decisions about which SPU should be discarded from a list or what color a SPU should become, if other considerations are equal, choices can be made in which jobs disenfranchised by the choice can be migrated. Note that N-way guests that fill a host to capacity are always immovable. To avoid infinite loops, once an LDOM has rejected a SPU, a global flag for the LDOM/SPU combination is flipped so the combination is not considered again for the optimization problem, or a SPU can remove all members of a selected color.

In one embodiment, a job can be moved with no swap partner if the two SPUs exchange equals or reduces the total error in the earlier color-blind solution and does not exceed the per SPU weight limit. Analysis of the multi-threaded move is performed at the cost of significantly more accounting.

Data structures can be supplied for solver functionality including item, permutation, and constraint structures. Optimization and analysis can be implemented with item lists. A locality domain (LDOM) conflicts data structure can be used to simplify comparisons.

Functions can be included for generating equivalence classes (equiv_class_generate), resolving LDOM conflicts (resolve_ldom_conflicts), and converting SPUs by color (convert_spus_by_color). The function for generating equivalence classes (equiv_class_generate) examines an item sorted list and, for example, arranges items with maximum minima and maxima into the same class. Lone entries are separated into a “none” class.

A “monochrome” function determines lists that include items of all one color. A build_equiv_lists function constructs equivalence lists by monitoring item permutations and constraints.

Other routines determine LDOM for each SPU including analysis of disallowed LDOMs, SPU ideal weight, SPU LDOM weight, immoveable SPU and LDOMs, total immoveable items, and the like.

In cases of a SPU for which appropriate allocation of a LDOM is unclear, a decide_best_color function can be supplied. The allocation can be unclear, for example, if a SPU is mixed color originally and should be assigned a color, or an LDOM is more appropriately associated with a different SPU so that a second choice LDOM is assigned to the SPU. The function can skip any LDOMs that previously rejected the SPU. A score is tallied according to characteristics of the LDOMs, for example wherein immoveables reduce the score. If SPU color is “NONE”, no good choice exists and the largest LDOM can be assigned to the SPU.

In a particular condition, a color can be the best color for more SPUs than can be held by a targeted LDOM. In some embodiments, SPUs can be relocated in the order of, first, a SPU that enables relocation of all jobs of a target color and has the least investment, and second, a SPU upon which the least amount of immobile weight is left.

A find_replacement function picks a replacement job that is a better fit for a current job on a SPU. A first job is located in a first SPU. A second job is taken from a second SPU for analysis. An ideal condition for swapping occurs when the second job matches the first SPU and the first job matches the second CPU. A good condition for swapping occurs when either the second job matches the first SPU or the first job matches the second CPU, and the non-matching combination is neutral. If neither combination matches, the swap is not performed.

A find_overloadable_spu function looks for an overloadable SPU where a thread can be moved. Analysis is performed to attempt to find a SPU which characteristics of, in preference order, a color that is appropriate for the thread, a color of NONE wherein the color has sufficient space for growth, or mixed. The analysis also seeks conditions in which weight of the old SPU minus the weight of the new SPU is greater than or equal to an ideal sought weight. Thus, the solution error always stays the same or improves.

A swap_items function switches the group field of two items to switch thread positions, and includes suitable accounting rebalancing. The swap_items function can operate as a short cut to avoid a complete two-item unlink and relink.

A move_all_from_spu function is a utility that can be used to remove all jobs of a certain type from a SPU. The function can be used when a LDOM is vacating a SPU and evacuation of all members is desired, or when the LDOM is taking over membership and removal of all other jobs is sought.

A reduce_ldom function is a utility that finds a maximum LDOM weight per SPU, and eliminates any members over the size limit.

A make_obvious_choices function is a utility that makes an additional pass through all items after equivalence lists have been built. The function maintains a running total of interesting values, and make first estimate at obvious color choices for SPUs.

A make_hard_choices function is an analysis routine that examines every MIXED color and determines the best color for conditions. Success is ensured in one pass because the subordinate routines never allow transition to MIXED color again. A reduction filter can be added to rapidly prevent less desirable allocations at the earliest decision point. The function enables an LDOM to properly set priorities before conditions become complicated. The function also frees SPUs so that better decisions can be made later.

A shrink_all_ldoms_to_fit function addresses a condition in which the administrator has specified more work to be done in an LDOM than will strictly fit.

A count_conflicts_remaining function is a utility that finds a total of the entitlement weight of vCPUs that failed to be placed on the best LDOM. The function is useful for deciding between two solutions that are otherwise very close.

A resolve_ldom_conflicts function is a utility that receives an unoptimized input condition and generates an output condition as a solution with swapping a SPU_color array and generates the aggregate error total of ldom_conflicts.

A convert_spus_by_color function is a utility that uses a color preference map to rearrange SPU mappings, resulting in a partial generation of the distribution. Non-LDOM groups call choices_by_spu later because the SPU list is ordered by least loaded (most favorable) SPU first in a distrib_t. LDOM members are, by definition, LDOM SPUs. Other items are color blind and kept in pure SPU weight sorted order. Items with no preference can be taken in any order, including trivial first-come-first-served.

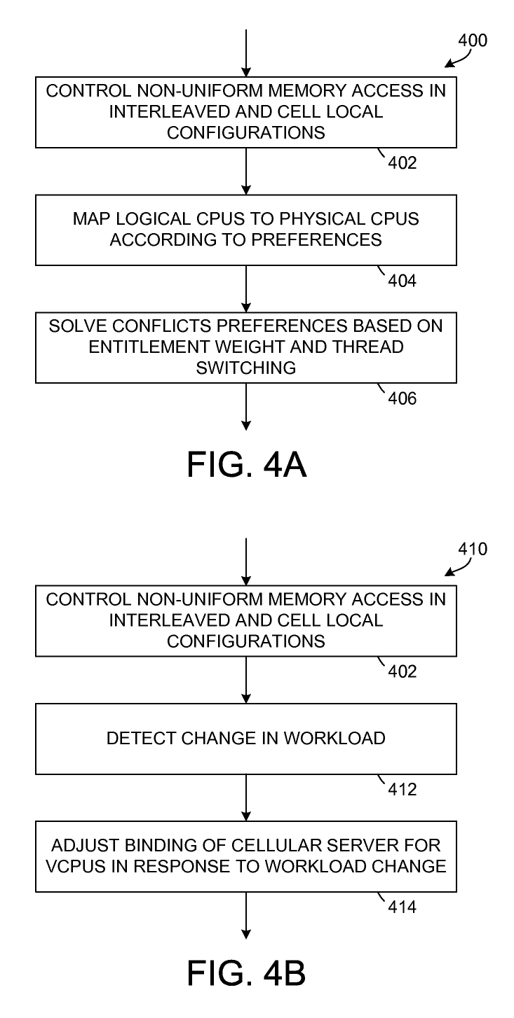

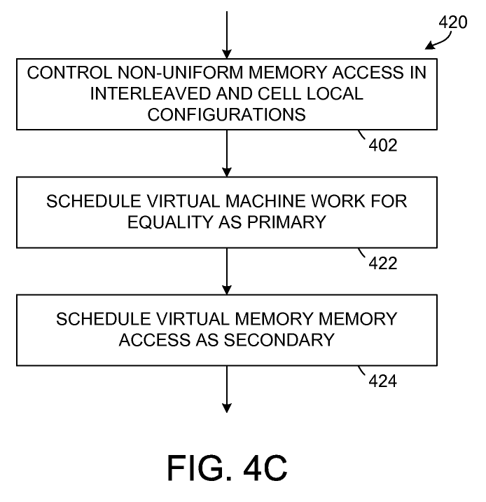

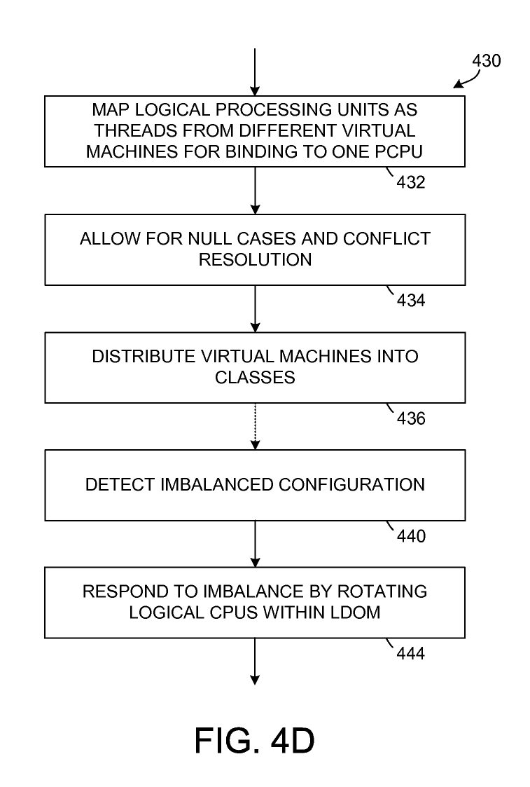

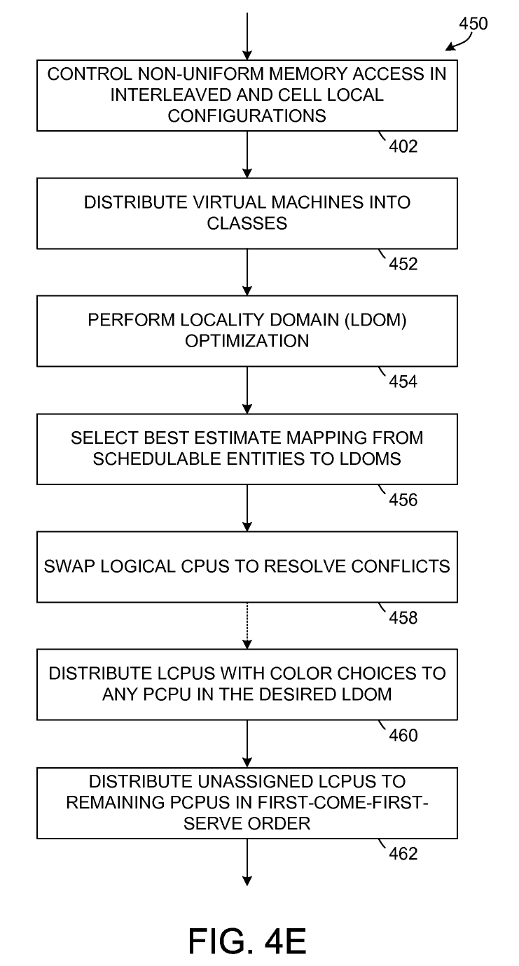

Referring to FIGS. 4A through 4E, flow charts illustrate one or more embodiments or aspects of a computer-executed method for virtual machine scheduling. As shown in FIG. 4A, the depicted method 400 comprises controlling 402 non-uniform memory access of a cellular server dynamically and with computed automation in interleaved and cell local configurations. Memory access is controlled 402 by mapping 404 logical central processing units (CPUs) to physical CPUs according to preference, and solving 406 conflicts in preference based on a predetermined entitlement weight and iterative switching of individual threads. In various embodiments and applications, solving 406 preference conflicts can include solving conflicts such as a condition in which the demand of logical CPUs exceeds the supply of physical CPUs, and a condition in which a logical CPU has preference for more than one physical CPU. For example, virtual machines with a highest assigned business priority can be assigned preference.

In some embodiments, the method 400 can further comprise enabling 408 selection of particular virtual machines for activation and inactivation of scheduling.

For example, the illustrative automated method 400 can be used to distribute virtual machine load over cells in a substantially equal allocation.

Referring to FIG. 4B, a flow chart illustrates a virtual machine control method 410 that dynamically adapts to operating conditions comprising detecting 412 a change in workload, and adjusting 414 binding of the cellular server in the interleaved and cell local configurations for multiple virtual central processing units (vCPUs) in response to the workload change.

Referring to FIG. 4C, in some embodiments 420 virtual machine memory access can be scheduled 424 as a secondary operation that supports primary scheduling 422 which schedules substantially equal virtual machine work for each of multiple physical CPUs.

As shown in FIG. 4D, an embodiment of a computer-executed method 430 for virtual machine scheduling can comprise mapping 432 logical processing units as a set of threads from different virtual machines for eventual binding to a single physical central processing unit (CPU) as a schedulable hardware entity defined by locality domain (LDOM) preferences while allowing 434 for null cases and conflict resolution. An illustrative mapping 432 procedure can comprise distributing 436 the virtual machines into classes, and including an equivalence class wherein members are equivalent in entitlement weight.

In some embodiments, multiple logical processing units can be mapped 432 with approximately equal entitlement weight.

In some embodiments, the method 430 can further comprise detecting 440 an imbalanced configuration and responding to the imbalanced configuration by, for example, rotating 444 logical CPUs within a locality domain (LDOM).

Referring to FIG. 4E, a flow chart illustrates a virtual machine control method 450 that dynamically adapts to operating conditions comprising distributing 452 the virtual machines into classes and performing 454 locality domain (LDOM) optimization. LDOM optimization 454 can comprise selecting 456 a best estimate mapping from schedulable hardware entities to LDOMs, and swapping 458 places between logical CPUs to remove conflicts between jobs executing on schedulable hardware entities.

In some embodiments, logical CPUs can be mapped 456 onto physical CPUs by distributing 460 the logical CPUs with color choices into any physical CPU in the desired LDOM. Unassigned logical CPUs are distributed 462 to remaining physical CPUs in first-come-first-served order.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A computer system comprising:
a virtual machine scheduler that dynamically and with computed automation controls non-uniform memory access of a cellular server in interleaved and cell local configurations comprising mapping logical central processing units (CPUs) to physical CPUs according to preference and solving conflicts in preference based on a predetermined entitlement weight and iterative switching of individual threads.

2. The computer system according to claim 1 further comprising:
the virtual machine scheduler adjusts binding of the cellular server in the interleaved and cell local configurations for a plurality of virtual central processing units (vCPUs) at a workload change.

3. The computer system according to claim 1 further comprising:
the virtual machine scheduler solves conflicts in preference including a condition of demand of logical central processing units (CPUs) exceeding supply of physical CPUs and a condition of a logical CPU with preference for more than one physical CPU.

4. The computer system according to claim 1 further comprising:
the virtual machine scheduler enables selection of particular virtual machines for activation and inactivation of scheduling.

5. The computer system according to claim 1 further comprising:
the virtual machine scheduler distributes virtual machine load over cells substantially equally.

6. The computer system according to claim 1 further comprising:
the virtual machine scheduler operates as a secondary scheduler that supports a primary scheduler which schedules substantially equal virtual machine work for each of a plurality of physical central processing units (CPUs).

7. The computer system according to claim 1 further comprising:
the virtual machine scheduler assigns preference to virtual machines with a highest assigned business priority.

8. The computer system according to claim 1 further comprising:
the virtual machine scheduler maps logical central processing units (CPUs) onto physical CPUs as schedulable hardware entities defined by locality domain (LDOM) preferences while allowing for null cases and conflicts to be resolved.

9. The computer system according to claim 1 further comprising:
the virtual machine scheduler that maps logical processing units as a set of threads from different virtual machines for eventual binding to a single physical central processing unit (CPU), the virtual machine scheduler mapping a plurality of logical processing units with approximately equal entitlement weight.

10. The computer system according to claim 9 further comprising:
the virtual machine scheduler that distributes groups of associated threads into classes.

11. The computer system according to claim 9 further comprising:
the virtual machine scheduler further comprising a scheduler agent that detects an imbalanced configuration and responds by rotating threads within a locality domain (LDOM).

12. The computer system according to claim 9 further comprising:
the virtual machine scheduler distributes the logical CPUs into classes and performs locality domain (LDOM) optimization comprising selecting a best estimate mapping from schedulable hardware entities to LDOMs, swapping places between logical CPUs to remove conflicts between jobs executing on schedulable hardware entities.

13. A computer-executed method for virtual machine scheduling comprising:
controlling non-uniform memory access of a cellular server dynamically and with computed automation in interleaved and cell local configurations comprising:
mapping logical central processing units (CPUs) to physical CPUs according to preference; and
solving conflicts in preference based on a predetermined entitlement weight and iterative switching of individual threads.

14. The method according to claim 13 further comprising:
detecting a change in workload; and
adjusting binding of the cellular server in the interleaved and cell local configurations for a plurality of virtual machine threads in response to the workload change.

15. The method according to claim 13 further comprising:
solving conflicts in preference including a condition of demand of logical central processing units (CPUs) exceeding supply of physical CPUs, and a condition of a logical CPU with preference for more than one physical CPU.

16. The method according to claim 13 further comprising:
enabling selection of particular virtual machines for activation and inactivation of scheduling.

17. The method according to claim 13 further comprising:
distributing virtual machine load over cells substantially equally.

18. The method according to claim 13 further comprising:
scheduling virtual machine memory access as a secondary operation that supports primary scheduling which schedules substantially equal virtual machine work for each of a plurality of physical central processing units (CPUs).

19. The method according to claim 13 further comprising:
assigning preference to virtual machines with a highest assigned business priority.

20. The method according to claim 13 further comprising:
mapping logical processing units as a set of threads from different virtual machines for eventual binding to a single physical central processing unit (CPU) as a schedulable hardware entity defined by locality domain (LDOM) preferences while allowing for null cases and conflicts to be resolved comprising:
distributing the logical CPUs into classes; and
including an equivalence class wherein members are equivalent in entitlement weight.

21. The method according to claim 13 further comprising:
mapping a plurality of logical processing units with approximately equal entitlement weight.

22. The method according to claim 13 further comprising:
detecting an imbalanced configuration and responding to the imbalanced configuration including rotating threads within a locality domain (LDOM).

23. The method according to claim 13 further comprising:
distributing the logical CPUs into classes and performing locality domain (LDOM) optimization comprising selecting a best estimate mapping from schedulable hardware entities to LDOMs, swapping places between logical CPUs to remove conflicts between jobs executing on schedulable hardware entities.

24. The method according to claim 13 further comprising:
mapping logical central processing units (CPUs) onto physical CPUs comprising distributing the logical CPUs into classes including an equivalence class wherein members are equivalent in entitlement weight.

25. An article of manufacture comprising:
a controller-usable medium having a computer readable program code embodied therein for virtual machine scheduling, the computer readable program code further comprising:
a code causing the controller to control non-uniform memory access of a cellular server dynamically and with computed automation in interleaved and cell local configurations comprising:
a code causing the controller to map logical central processing units (CPUs) to physical CPUs according to preference; and
a code causing the controller to solve conflicts in preference based on a predetermined entitlement weight and iterative switching of individual threads.
